(19) United States
(12) Patent Application Publication
(10) Pub. No.: US 2019/0316416 A1
(43) Pub. Date: Oct. 17, 2019

(54) Rescue Ladder

(71) Applicant: GOODRICH CORPORATION, Charlotte, NC (US)

(72) Inventors: Timothy C. Haynes, Prescott Valley, AZ (US); Michael A. Luzader, Laveen, AZ (US)

(73) Assignee: GOODRICH CORPORATION, Charlotte, NC (US)

(21) Appl. No.: 15/952,560

(22) Filed: Apr. 13, 2018

(51) Int. Cl. E06C 1/56; B63C 9/04; B64D 25/14

(52) U.S. Cl. CPC E06C 1/56; B63C 2009/042; B64D 25/14; B63C 9/04

(57) ABSTRACT

Systems and methods are disclosed herein for a rescue ladder. The rescue ladder may include a cross member disposed between a first longitudinal member and a second longitudinal member and coupled to the first longitudinal member and the second longitudinal member. The rescue ladder may include a handle member coupled with at least one of the first longitudinal member, the second longitudinal member, or the cross member.

### FIELD

The present disclosure relates generally to aircraft evacuation assemblies, and more specifically to rescue ladders.

### BACKGROUND

In the event of an emergency water landing, aircraft typically include inflatable structures that may be used as at least one of a slide to exit the aircraft or a flotation device (e.g. life raft) separate from the aircraft. In the event of a person going overboard, it is beneficial to have a rescue ladder readily accessible to assist in bringing the person from the water onto the inflatable structure safely.

### SUMMARY

According to various embodiments, a rescue ladder is described herein. The rescue ladder may include a cross member disposed between a first longitudinal member and a second longitudinal member and coupled to the first longitudinal member and the second longitudinal member. The rescue ladder may include a handle member coupled to at least one of the first longitudinal member, the second longitudinal member, or the cross member. According to various embodiments, the handle member comprises a buoyant material configured to float in water. According to various embodiments, the handle member comprises a webbing material disposed radially outward of a buoyant material configured to float in water. According to various embodiments, the handle member comprises a loop handle. According to various embodiments the handle member comprises a support cable disposed across and coupled with the first and the second longitudinal members. According to various embodiments, the rescue ladder may include a third longitudinal member disposed between the first longitudinal member and second longitudinal member. According to various embodiments, the rescue ladder couples with an inflatable structure. According to various embodiments, the inflatable structure is at least one of a life raft or slide.

According to various embodiments, an inflatable structure is disclosed. The inflatable structure may include a rescue ladder having at a first end and a second end. The rescue ladder may include a cross member disposed between a first longitudinal member and a second longitudinal member and coupled to the first longitudinal member and the second longitudinal member, wherein the first longitudinal member and the second longitudinal member extend from the first end to the second end, wherein the first longitudinal member is bonded to the inflatable structure at the first end at a first attachment point above a horizontal centerline of the inflatable structure, wherein the second longitudinal member is bonded to the inflatable structure at the first end at a second attachment point above a horizontal centerline of the inflatable structure. The rescue ladder may include a handle member coupled to at least one of the first longitudinal member, the second longitudinal member, or the cross member. According to various embodiments, the handle member comprises a buoyant material configured to float in water. According to various embodiments, the handle member comprises a webbing material disposed radially outward of a buoyant material configured to float in water. According to various embodiments, the handle member comprises a loop handle. According to various embodiments, the handle member comprises a support cable disposed across and coupled with the first and the second longitudinal members. According to various embodiments, the rescue ladder may include a third longitudinal member disposed between the first longitudinal member and second longitudinal member, wherein the third longitudinal member is bonded to the inflatable structure at the first end at a third attachment point above a horizontal centerline of the inflatable structure. According to various embodiments, the rescue ladder couples with an inflatable structure. According to various embodiments, the inflatable structure is at least one of a life raft or slide.

According to various embodiments, a method of making a rescue ladder for an inflatable structure is disclosed. The method may include coupling a first longitudinal member of the rescue ladder to the inflatable structure at a first attachment point above a horizontal centerline of the inflatable structure. The method may include coupling a second longitudinal member of the rescue ladder to the inflatable structure at a second attachment point above the horizontal centerline of the inflatable structure. According to various embodiments, the method may include coupling a handle member to at least one of the first longitudinal member or the second longitudinal member. According to various embodiments, the method may include coupling a cross member to the first longitudinal member and the second longitudinal member.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1A illustrates an inflatable life raft with a rescue ladder in accordance with various embodiments;

FIG. 1B illustrates an inflatable slide with a rescue ladder in accordance with various embodiments;

FIG. 2A illustrates a rescue ladder in accordance with various embodiments;

FIG. 2B illustrates a rescue ladder in accordance with various embodiments;

FIG. 3 illustrates a flow diagram of a process for making a rescue ladder for an inflatable structure in accordance with various embodiments.

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

### DETAILED DESCRIPTION

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Surface shading lines may be used throughout the figures to denote different parts but not necessarily to denote the same or different materials. In some cases, reference coordinates may be specific to each figure.

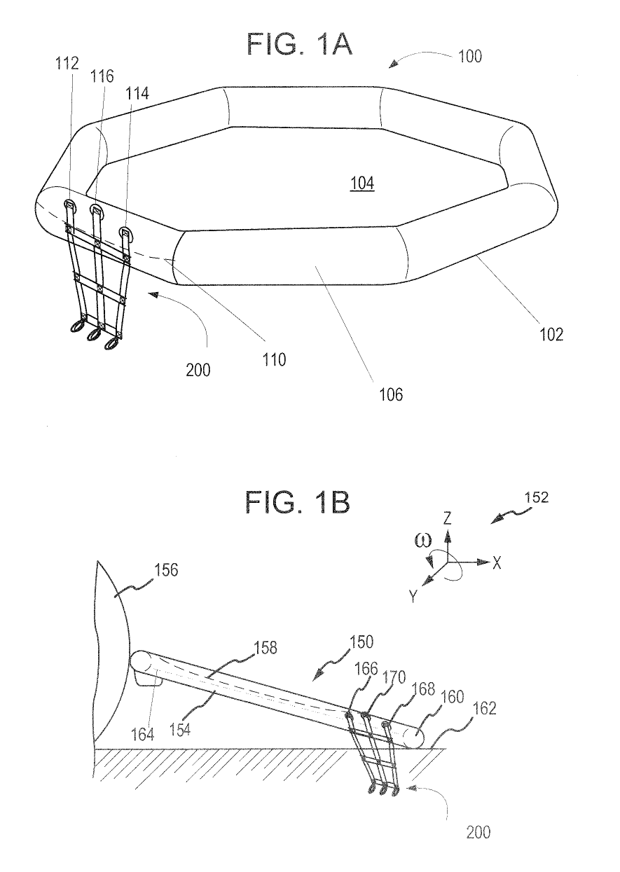

In various embodiments, FIGS. 1A and 1B illustrate different examples of inflatable structures. In various embodiments, and with reference to FIG. 1A, the inflatable structure may be life raft 100. The life raft 100 generally includes a base 102. The base 102 has a first side 104 and a second side 106 opposite the first side 104. In various embodiments, the first side 104 of the base 102 of the life raft 100 may be a top surface of the life raft 100 upon which passengers are supported in response to the life raft 100 being deployed in water. That is, the base 102 of the life raft 100 may be inflatable and may thus be configured to float on water. In various embodiments, the base 102 may include a border tube 106. Border tubes 106 may provide buoyancy to the life raft 100. Using base 102 as a centerline axis, border tube 106 is disposed above (positive Y-direction) base 102, and base 102 may be disposed proximate a body of water. The border tube 106 may provide a degree of buoyancy redundancy in that it may be capable of supporting the weight of the life raft 100 when filled with passengers. The border tube 106 may circumscribe the first side 104 of the base 102. The life raft 100 may include one or more rescue ladders 200 or one or more rescue ladders 250 to facilitate passenger embarking and person-overboard rescuing. Herein, a “person-overboard” refers to a human subject located in water. The person-overboard may be exhausted, injured or unconscious from the water and may need to be assisted into an inflatable structure.

In various embodiments, and with reference to FIG. 1B, the inflatable structure may be inflatable slide 150. Inflatable slide 150 may include a support structure 154. According to various embodiments, the inflatable slide 150 is inflatable (and is shown in an inflated state in the figures; i.e. extending downwards along the “z” axis of reference axis 152, and forwards in the “x” direction). According to various embodiments, inflatable slide 150 is used for emergency evacuation. According to various embodiments, inflatable slide 150 is used for emergency evacuation of an aircraft 156 and is configured to pack within a compartment of the aircraft (i.e. the aircraft door, a slide bustle, etc.). According to various embodiments, inflatable slide 150 comprises a sliding surface 158, wherein the support structure 154 is in bordering engagement with the sliding surface 158. According to various embodiments, at least the support structure 154 of inflatable slide 150 is inflatable. According to various embodiments, sliding surface 158 comprises a flexible fabric material such as a urethane rip stop material and/or a nylon based cloth with a urethane coating. According to various embodiments, ground rail 160 may rest on ground surface 162, including water. Inflatable slide 150 may include one or more rescue ladders 200 or one or more rescue ladders 250 to facilitate passenger embarking and person-overboard rescuing.

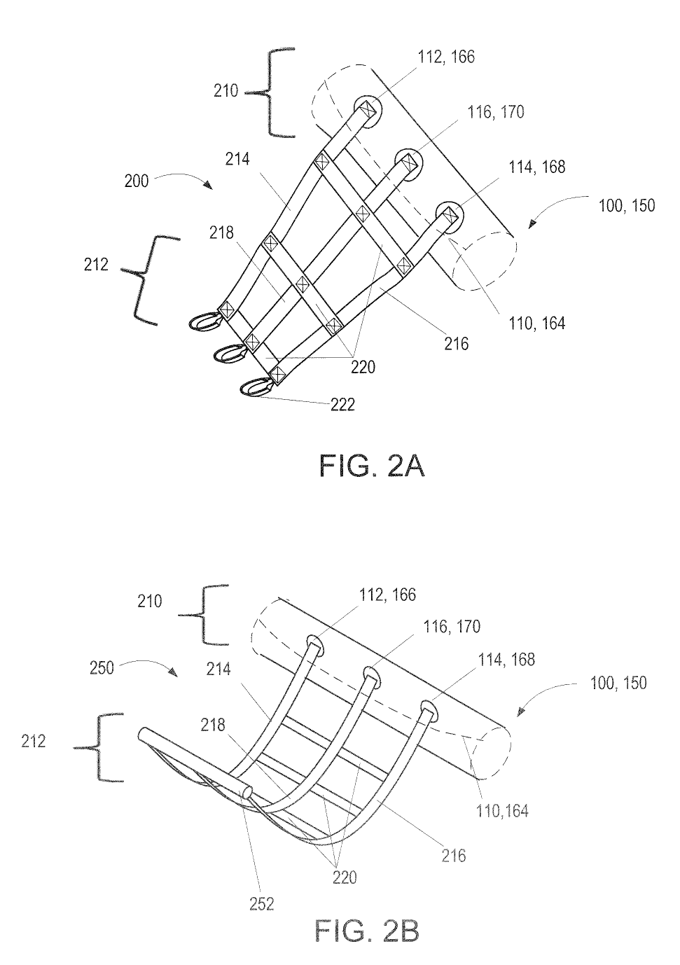

In various embodiments, and with reference to FIG. 2A, rescue ladder 200 is provided. Rescue ladder 200 may comprise a flexible fabric material such as a urethane rip stop material and/or a nylon based cloth with a urethane coating. Rescue ladder 200 may comprise a first end 210 and a second end 212.

Rescue ladder 200 may comprise a first longitudinal member 214 and a second longitudinal member 216. First longitudinal members 214 and a second longitudinal member 216 may extend from the first end 210 of rescue ladder 200 to the second and 212 of rescue ladder 200. Rescue ladder 200 may comprise a third longitudinal member 218 disposed between first longitudinal member 214 and a second longitudinal member 216. Third longitudinal member 218 may extend from the first end 210 of rescue ladder 200 to the second and 212 of rescue ladder 200. Rescue ladder 200 may comprise additional longitudinal members disposed between first longitudinal member 214 and a second longitudinal member 216. The first longitudinal member 214, second longitudinal member 216, and third longitudinal member 218 may be disposed parallel to one another and may be evenly spaced from one another.

At first end 210 of rescue ladder 200, the first longitudinal member 214, second longitudinal member 216, and third longitudinal member 218 may each be bonded to the inflatable structure by any suitable bonding method, for example, but not limited to, stitching or gluing.

With reference to FIG. 1A and FIG. 2A, in various embodiments, first longitudinal member 214 may be bonded to border tube 106 of life raft 100 at a first attachment point 112. In various embodiments, second longitudinal member 216 may be bonded to border tube 106 of life raft 100 at a second attachment point 114. In various embodiments, third longitudinal member 218 may be bonded to border tube 106 of life raft 100 at a third attachment point 116. Using horizontal centerline 110 as a centerline axis, first attachment point 112, second attachment point 114, and third attachment point 116 may each be above (positive y-axis) horizontal centerline 110.

As shown in FIG. 1B and FIG. 2A, in various embodiments, first longitudinal member 214 may be bonded to support structure 154 of inflatable slide 150 at a first attachment point 166. In various embodiments, second longitudinal member 216 may be bonded to support structure 154 of inflatable slide 150 at a second attachment point 168. In various embodiments, third longitudinal member 218 may be bonded to support structure 154 of intlatable slide 150 at a third attachment point 170. Using horizontal centerline 164 as a centerline axis, first attachment point 166, second attachment point 168, and third attachment point 170 may be above (positive y-axis) horizontal centerline 164.

Referring back to FIG. 2A, rescue ladder 200 may comprise a cross member 220 disposed between and coupled with first longitudinal member 214 and second longitudinal member 216. Rescue ladder 200 may comprise any number of cross members 220 disposed between and coupled with the first longitudinal member 214 and the second longitudinal member 216. Rescue ladder 200 may comprise three cross members 220. Cross members 220 may be bonded to first longitudinal member 214 and second longitudinal member 216 by any suitable bonding method, for example stitching or gluing. Cross members 220 may be disposed parallel to one another and evenly spaced from one another.

Rescue ladder 200 may comprise handle member 222 coupled with at least one of the first longitudinal member 214, the second longitudinal member 216, or the cross member 220. Handle member 222 may comprise a loop handle or a plurality of loop handles (e.g. three loop handles). Handle member 222 may comprise a buoyant material (e.g. foam) configured to float in water. Handle member 222 may comprise a webbing material disposed radially outward of a buoyant material. Handle member 222 may be configured so that a person may use the handle member 222 as a grip or to pull onto (i.e. above, positive y-direction) the rescue ladder. In various embodiments, a person on the inflatable structure may use handle member 222 as a grip to pull towards the inflatable structure when assisting the person onto the inflatable structure.

In various embodiments, and with reference to FIG. 2B, rescue ladder 250 is provided. Rescue ladder 250 comprises many of the same components as rescue ladder 200, as shown in FIG. 2A, and may be used interchangeably with rescue ladder 200 as shown in FIG. 1A and FIG. 1B. Rescue ladder 250 may comprise handle member 252 coupled with at least one of the first longitudinal member 214, the second longitudinal member 216, or cross member 220. Handle member 252 may comprise a buoyant material (e.g. foam) configured to float in water. Handle member 252 may comprise a webbing material disposed radially outward of a buoyant material. Handle member 252 may be configured so that a person may use the handle member 252 as a grip or to pull onto (i.e. above, positive y-direction) the rescue ladder. In various embodiments, a person on the inflatable structure may use handle member 252 as a grip to pull towards the inflatable structure when assisting the person onto the inflatable structure. Handle member 252 may comprise a support cable, which may be disposed across and coupled with at least the first longitudinal member 214 and the second longitudinal member 216. Handle member 252 may comprise any shape, for example, a cylinder.

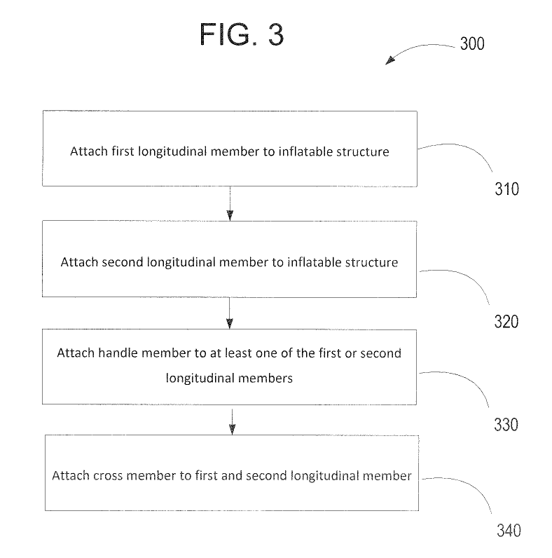

In various embodiments and with reference to FIG. 3, a flow diagram of a process 300 for making a rescue ladder for an inflatable structure is shown. A first longitudinal member of the rescue ladder may be coupled to the inflatable structure at a first attachment point above a horizontal centerline of the inflatable structure (Step 310). In various embodiments, a second longitudinal member of the rescue ladder may be coupled to the inflatable structure at a second attachment point above a horizontal centerline of the inflatable structure (Step 320). In various embodiments, a handle member may be coupled to at least one of the first longitudinal member or the second longitudinal member (Step 330). In various embodiments, a cross member may be coupled to the first longitudinal member and the second longitudinal n e ember (Step 340).

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “various embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A rescue ladder for an inflatable structure comprising:
a first end;
a second end distal of the first end;
a first longitudinal member and a second longitudinal member each extending between the first end and the second end;
a cross member coupled to and extending between the first longitudinal member and the second longitudinal member; and
a handle member, configured to float in water, coupled to at least one of the first longitudinal member or the second longitudinal member at the second end, wherein the handle member comprises a buoyant material retained within a webbing material,
wherein the first longitudinal member and the second longitudinal member are coupled at the first end to an inflatable member of the inflatable structure and above a horizontal centerline of the inflatable structure.

2. (canceled)

3. The rescue ladder of claim 1, wherein the handle member comprises a webbing material disposed radially outward of a buoyant material configured to float in water.

4. The rescue ladder of claim 1, wherein the handle member comprises a loop handle.

5. The rescue ladder of claim 1, wherein the handle member comprises a support cable disposed across and coupled to the first and the second longitudinal members.

6. The rescue ladder of claim 1, further comprising a third longitudinal member disposed between the first longitudinal member and second longitudinal member, wherein the handle member is coupled at the second end to each of the first longitudinal member, the second longitudinal member, and the third longitudinal member.

7. (canceled)

8. The rescue ladder of claim 1, wherein the inflatable structure is at least one of a life raft or slide.

9. An inflatable structure comprising:
an inflatable member;
a rescue ladder having at a first end and a second end, wherein the rescue ladder comprises a cross member disposed between a first longitudinal member and a second longitudinal member and coupled to the first longitudinal member and the second longitudinal member,
wherein the first longitudinal member and the second longitudinal member extend from the first end to the second end,
wherein the first longitudinal member is bonded to the inflatable member at the first end at a first attachment point above a horizontal centerline of the inflatable structure, wherein the second longitudinal member is bonded to the inflatable member at the first end at a second attachment point above the horizontal centerline of the inflatable structure; and
a handle member, configured to float in water, coupled to at least one of the first longitudinal member or the second longitudinal member distal of the respective first attachment point or second attachment point, wherein the handle member comprises a buoyant material retained within a webbing material.

10. The inflatable structure of claim 9, wherein the inflatable structure is at least one of a life raft or slide.

11. (canceled)

12. The inflatable structure of claim 9, wherein the handle member comprises a webbing material disposed radially outward of a buoyant material configured to float in water.

13. The inflatable structure of claim 9, wherein the handle member comprises a loop handle.

14. The inflatable structure of claim 9, wherein the handle member comprises a support cable disposed across and coupled with the first and the second longitudinal members.

15. The inflatable structure of claim 9, wherein the handle member comprises a loop handle.

16. (canceled)

17. The inflatable structure of claim 9, further comprising a third longitudinal member disposed between the first longitudinal member and second longitudinal member, wherein the third longitudinal member is bonded to the inflatable member at the first end at a third attachment point above the horizontal centerline of the inflatable structure, wherein the third longitudinal member is disposed relatively orthogonal to the cross member.

18. A method of making a rescue ladder for an inflatable structure, comprising the steps of:
coupling a first longitudinal member of the rescue ladder to the inflatable structure at a first attachment point above a horizontal centerline of the inflatable structure; and
coupling a second longitudinal member of the rescue ladder to the inflatable structure at a second attachment point above the horizontal centerline of the inflatable structure.

19. A method of claim 18, further comprising coupling a handle member to at least one of the first longitudinal member or the second longitudinal member.

20. A method of claim 18, further comprising coupling a cross member to the first longitudinal member and the second longitudinal member.
